(19) United States
(12) Patent Application Publication
(10) Pub. No.: US 2026/0328668 A1
(43) Pub. Date: Oct. 22, 2026

(54) DETECTION DEVICE

(71) Applicant: Japan Display Inc., Tokyo (JP)

(72) Inventors: Kaoru ITO, Tokyo (JP); Norio MAMBA, Tokyo (JP); Daichi ABE, Tokyo (JP); Yoshihiro SEKIGUCHI, Tokyo (JP)

(21) Appl. No.: 19/648,259

(22) Filed: Apr. 15, 2026

(30) Foreign Application Priority Data
Apr. 18, 2025 (JP) 2025-068650

(51) Int. Cl. G01N 15/075

(52) U.S. Cl. CPC G01N 15/075

(57) ABSTRACT

According to an aspect, a detection device includes: a light source; a planar optical sensor having optical sensors; an object placement member provided to allow an object to be detected to be placed such that the object to be detected is interposed between the light source and the planar optical sensor; and a processor. The processor is configured to determine that a position of the object to be detected has changed when a first condition and a second condition are satisfied. The first condition is that, for each of one or more of the optical sensors, a difference between its outputs obtained at two time points exceeds a first predetermined value. The second condition is that a difference between two overall outputs of the entire planar optical sensor obtained at the two time points does not exceed a second predetermined value.

### CROSS-REFERENCE TO RELATED APPLICATION

This application claims the benefit of priority from Japanese Patent Application No. 2025-068650 filed on Apr. 18, 2025, the entire contents of which are incorporated herein by reference.

### BACKGROUND

### 1. Technical Field

What is disclosed herein relates to a detection device.

### 2. Description of the Related Art

Devices are known that acquire an image by imaging a culture medium (e.g., agar) for culturing samples to be cultured such as bacteria and detect colonies of the samples to be cultured formed on the culture medium from the image (for example, Japanese Patent Application Laid-open Publication No. 2012-080802 (JP-A-2012-080802)).

In a device according to JP-A-2012-080802, if a dish containing the culture medium is displaced after being placed, a change in the image due to the displacement may be detected as a change in the image due to formation of the colonies on the culture medium. Therefore, the change in the image due to the displacement of the dish containing the culture medium needs to be determined to be different from the change in the image due to formation of the colonies on the culture medium.

For the foregoing reasons, there is a need for a detection device that can determine a change in an image due to displacement of a dish containing a culture medium to be a change different from a change in the image due to formation of colonies on the culture medium.

### SUMMARY

According to an aspect, a detection device includes: a light source configured to emit light; a planar optical sensor where a plurality of optical sensors configured to detect the light from the light source are two-dimensionally arranged; an object placement member provided so as to allow an object to be detected to be placed such that the object to be detected is interposed between the light source and the planar optical sensor; and a processor configured to perform operation control of the light source and the planar optical sensor and processing based on a plurality of outputs of the optical sensors. The object to be detected is a culture medium accommodated in a dish of a container. The processor is configured to determine that a position of the object to be detected has changed when a first condition and a second condition are satisfied. The first condition is that, for each of one or more of the optical sensors, a difference between its outputs obtained at two time points separated by a predetermined amount of time or longer exceeds a first predetermined value. The second condition is that a difference between two overall outputs of the entire planar optical sensor obtained at the two time points does not exceed a second predetermined value.

According to an aspect, a detection device includes: a light source configured to emit light; a planar optical sensor where a plurality of optical sensors configured to detect the light from the light source are two-dimensionally arranged; an object placement member provided so as to allow an object to be detected to be placed such that the object to be detected is interposed between the light source and the planar optical sensor; and a processor configured to perform operation control of the light source and the planar optical sensor and processing based on a plurality of outputs of the optical sensors. The object to be detected is a culture medium accommodated in a dish of a container. The processor is configured to: identify a circumferential outline appeared, due to the edge of the dish, in outputs of the planar optical sensor, using the Hough transform, and determine that the position of the object to be detected has changed, when a difference between two outputs of the optical sensor overlapping the outline that are obtained at two time points separated by a predetermined amount of time or longer exceeds a first predetermined value.

### BRIEF DESCRIPTION OF THE DRAWINGS

FIG. 1 is a diagram illustrating a main configuration of a detection device;

FIG. 2 is a diagram illustrating a configuration example of a detection area and a wiring area;

FIG. 3 is a circuit diagram illustrating a circuit configuration of an optical sensor;

FIG. 4 illustrates schematic views illustrating configuration examples of a light source;

FIG. 5 is a schematic diagram schematically illustrating a configuration example of a detection system;

FIG. 6 is a schematic diagram illustrating a relation between one detection device and an external configuration;

FIG. 7 is a schematic view illustrating a structure of various parts including main components of the detection device and an object to be detected that is placed on the detection device;

FIG. 8 illustrates schematic views illustrating examples of images obtained in a first embodiment of the present disclosure;

FIG. 9 is a flowchart of a process related to operations of the detection device;

FIG. 10 is a flowchart of an initial process;

FIG. 11 is a flowchart of a periodic operation;

FIG. 12 is a diagram explaining the Hough transform; and

FIG. 13 is a flowchart of a process related to operations of a detection device 1 according to a second embodiment of the present disclosure.

### DETAILED DESCRIPTION

The following describes embodiments of the present disclosure with reference to the drawings. What is disclosed herein is merely an example, and the present disclosure naturally encompasses appropriate modifications easily conceivable by those skilled in the art while maintaining the gist of the present invention. To further clarify the description, the drawings may schematically illustrate, for example, widths, thicknesses, and shapes of various parts as compared with actual aspects thereof. However, they are merely examples, and interpretation of the present disclosure is not limited thereto. The same element as that described with reference to an already mentioned drawing is denoted by the same reference numeral through the present specification and the drawings, and detailed description thereof may not be repeated where appropriate.

### First Embodiment

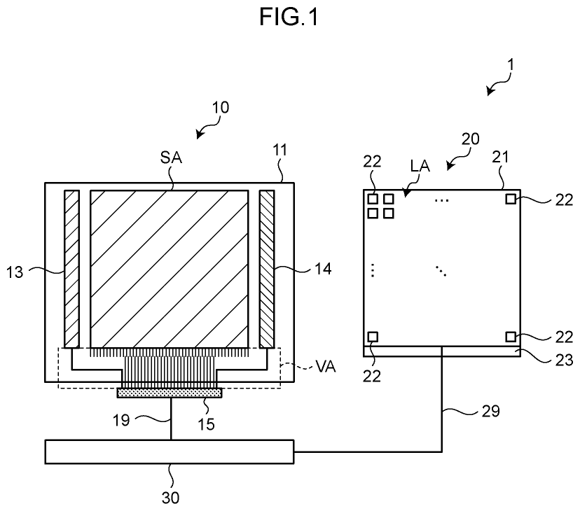

FIG. 1 is a diagram illustrating a main configuration of a detection device 1. The detection device 1 includes a planar optical sensor 10, a light source panel 20, and a control circuit 30. The planar optical sensor 10 and the light source panel 20 of the detection device 1 are coupled to the control circuit 30.

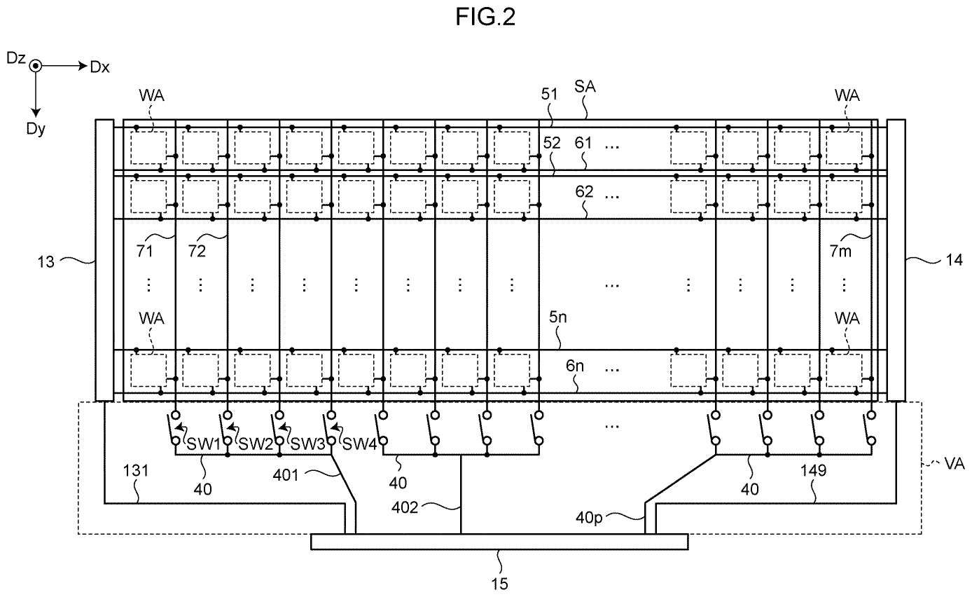

The planar optical sensor 10 is provided with a detection area SA (refer to FIG. 2) on a substrate 11. A reset circuit 13, a scan circuit 14, and a wiring area VA are provided on the substrate 11. Components on the detection area SA, the reset circuit 13, and the scan circuit 14 are coupled to a detection circuit 15 via the wiring area VA.

The light source panel 20 has a light-emitting area LA that emits light to the detection area SA. The light source panel 20 is provided with a light source 22 on a substrate 21. The light source 22 emits light. Specifically, the light source 22 includes a light-emitting element such as a light-emitting diode (LED) and is provided in the light-emitting area LA. In the example illustrated in FIG. 1, a plurality of the light sources 22 are arranged in a matrix having a row-column configuration on the substrate 21.

The light source panel 20 is provided with a light source drive circuit 23. Under the control of the control circuit 30, the light source drive circuit 23 controls turning on and off of each of the light sources 22 and the luminance thereof when being turned on. The light sources 22 may be provided to allow individual control of light emission or may be provided so as to emit light collectively.

The control circuit 30 performs various processes related to operations of the detection device 1. Specifically, the control circuit 30 is a circuit, such as a field-programmable gate array (FPGA) that can implement a plurality of functions. The control circuit 30 may have other configurations, such as an application-specific integrated circuit (ASIC). The control circuit 30 is coupled to the light source drive circuit 23 via wiring 29 and performs processing related to the lighting of the light sources 22, such as determination of lighting patterns and lighting timing of the light sources 22.

The control circuit 30 is coupled to the detection circuit 15 via wiring 19 and obtains an output from the detection circuit 15. The control circuit 30 also controls the timing of obtaining the output from the detection circuit 15, that is, the timing of operating the scan circuit 14 so as to provide a gate signal to a scan line 6. Thus, the control circuit 30 controls operations of the light sources 22 and the planar optical sensor 10. The control circuit 30 further performs processes based on outputs of a plurality of optical sensors WA. Such processes include a process to determine whether the position of an object to be detected 200 has changed, a process to determine whether colonies have formed, and other processes. Such processes will be described later.

Although not illustrated in the drawings, the detection device 1 includes an analog-to-digital conversion circuit, a digital-to-analog conversion circuit, and other components. The analog-to-digital conversion circuit is a circuit for allowing the outputs from the optical sensors WA (refer to FIG. 2) transmitted via the detection circuit 15 to be handled in arithmetic processing by the control circuit 30. The digital-to-analog conversion circuit is a circuit for allowing digital signals generated by the arithmetic processing of the control circuit 30 to be used for controlling the operations of the planar optical sensor 10 and the light source panel 20. These circuits may be included, for example, in part or in whole in the detection circuit 15. These circuits may alternatively be functions performed by circuits mounted on flexible printed circuits (FPCs) provided as the wiring 19 and the wiring 29. These circuits may alternatively be mounted in other ways on the detection device 1.

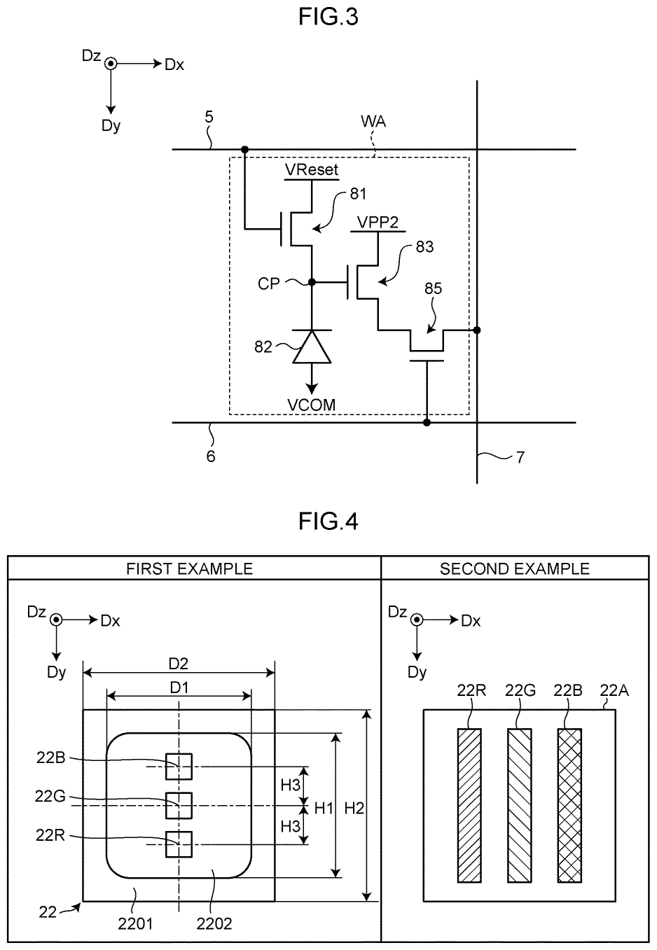

FIG. 2 is a diagram illustrating a configuration example of the detection area SA and the wiring area VA. The multiple optical sensors WA (FIG. 3) are two-dimensionally arranged in the detection area SA of the planar optical sensor 10. In a first embodiment of the present disclosure, as illustrated in FIG. 2, the optical sensors WA are arranged in a matrix having a row-column configuration along a first direction Dx and a second direction Dy. The first direction Dx is orthogonal to the second direction Dy. In the following description, the term “third direction Dz” refers to a direction orthogonal to the first direction Dx and the second direction Dy.

The reset circuit 13 is coupled to reset signal transmission lines 51, 52, . . . , 5n. Hereinafter, the term “reset signal transmission line 5” refers to any one of the reset signal transmission lines 51, 52, . . . , 5n. The reset signal transmission line 5 is wiring along the first direction Dx. In the example illustrated in FIG. 2, n reset signal transmission lines 5 are arranged in the second direction Dy. n is a natural number equal to or larger than 2. The n reset signal transmission lines 5 are each coupled, at one end in the first direction Dx, to the reset circuit 13.

The scan circuit 14 is coupled to scan lines 61, 62, . . . , 6n. Hereinafter, the term “scan line 6” refers to any one of the scan lines 61, 62, . . . , 6n. The scan line 6 is wiring along the first direction Dx. In the example illustrated in FIG. 2, n scan lines 6 are arranged in the second direction Dy. The n scan lines 6 are each coupled, at the other end in the first direction Dx, to the scan circuit 14.

As illustrated in FIG. 2, the reset signal transmission lines 5 and the scan lines 6 are alternately arranged in the second direction Dy in the detection area SA. The reset circuit 13 and the scan circuit 14 illustrated in FIGS. 1 and 2 are arranged at locations facing each other with the detection area SA interposed therebetween, but the layout of the reset circuit 13 and the scan circuit 14 is not limited to this layout and can be changed as appropriate.

Signal lines 71, 72, . . . , 7m are also provided in the detection area SA. Hereinafter, the term “signal line 7” refers to any one of the signal lines 71, 72, . . . , 7m. The signal line 7 is wiring along the second direction Dy.

In the example illustrated in FIG. 2, m signal lines 7 are arranged in the first direction Dx. m is a natural number equal to or larger than 2. The m signal lines 7 are each coupled, at one end in the second direction Dy, to one of a plurality of switches (for example, a switch SW1, a switch SW2, a switch SW3, or a switch SW4) included in a multiplexer 40.

The multiplexer 40 is provided in the wiring area VA. The multiplexer 40 includes a plurality of switches. In the example illustrated in FIG. 2, the switches SW1, SW2, SW3, and SW4 are illustrated as the switches. The switches included in one multiplexer 40 are turned on (conducting state) at different times from one another. During a period when one of the switches included in one multiplexer 40 is on (conducting state), the other switches are off (non-conducting state). The number of the multiplexers 40 corresponds to the number (m) of the signal lines 7. When the number of the switches is p, m/p is sufficient as the number of the multiplexers 40. When more than one multiplexer 40 are provided, each of the multiplexers 40 is coupled to the detection circuit 15 via an individual one of wiring lines 401, 402, . . . , 40p.

The coupling between the signal lines 7 and the detection circuit 15 via the multiplexer 40 is merely exemplary and is not limited to this example. The signal lines 7 may be individually directly coupled to the detection circuit 15 in the wiring area VA. In the wiring area VA, the reset circuit 13 is coupled to the detection circuit 15 via wiring 131. In the wiring area VA, the scan circuit 14 is coupled to the detection circuit 15 via wiring 149.

In the detection of light by a photodiode (PD) 82 (refer to FIG. 3) provided in the optical sensor WA, the detection circuit 15 outputs signals to control operation timing of the reset circuit 13 and the scan circuit 14 under the control of the control circuit 30. The detection circuit 15 receives the outputs from the optical sensors WA. The detection circuit 15 converts the signals received from the optical sensors WA into data that can be interpreted by the control circuit 30 and outputs the data to the control circuit 30. The detection circuit 15 of the first embodiment is a microcontroller unit (MCU).

FIG. 3 is a circuit diagram illustrating a circuit configuration of the optical sensor WA. The first direction Dx and the second direction Dy in FIG. 3 merely correspond to the directions of the reset signal transmission lines 5, the scan lines 6, and the signal lines 7, and do not exactly indicate the relative positional relation of the circuit configuration in the optical sensor WA.

As illustrated in FIG. 3, a switching element 81, the PD 82, a transistor element 83, and a switching element 85 are provided in the optical sensor WA. The PD 82 is a photodiode (PD). The switching elements 81 and 85 and the transistor element are metal-oxide semiconductor field-effect transistors (MOSFETs).

The gate of the switching element 81 is coupled to the reset signal transmission line 5. One of the source and the drain of the switching element 81 is supplied with a reset potential VReset. The other of the source and the drain of the switching element 81 is coupled to the cathode of the PD 82 and the gate of the transistor element 83. Hereinafter, the term “coupling part CP” refers to a point where the other of the source and the drain of the switching element 81 is coupled to the cathode of the PD 82 and the gate of the transistor element 83. A reference potential VCOM is supplied from the anode side of the PD 82. The potential difference between the reset potential VReset and the reference potential VCOM is set in advance, but the reset potential VReset and the reference potential VCOM may be variable. The reset potential VReset is higher than the reference potential VCOM.

The drain of the transistor element 83 serving as a source follower is supplied with an output source potential VPP2. The source of the transistor element 83 is coupled to one of the source and the drain of the switching element 85. The other of the source and the drain of the switching element 85 is coupled to the signal line 7. The gate of the switching element 85 is coupled to the scan line 6.

The reset potential VReset, the reference potential VCOM, and the output source potential VPP2 are supplied by the detection circuit 15 to the optical sensor WA based on, for example, electric power supplied via a power supply circuit (not illustrated) coupled to the detection circuit 15. The way of outputting these potentials is not limited to this way and can be changed as appropriate.

The output source potential VPP2 is set in advance. The potential on the source side of the transistor element 83 is a potential lower than the output potential of the PD 82 by a voltage (Vth) between the gate and the source of the transistor element 83. In this case, the potential on the source side of the transistor element 83 corresponds to the reset potential VReset and the reference potential VCOM. The potential of the output of the PD 82 corresponds to photovoltaic power generated by the PD 82 in response to the light detected by the PD 82 during an exposure period.

When the gate of the switching element 85 is turned on by the gate signal supplied from the scan circuit 14 via the scan line 6, the source and the drain of the switching element 85 are brought into a conducting state therebetween. This operation transmits, to the signal line 7 via the switching element 85, a signal (potential) transmitted via the transistor element 83 to the switching element 85. Thus, the output from the optical sensor WA is generated. Hereinafter, the term “gate signal” refers to the signal (potential) supplied from the scan circuit 14 via the scan line 6. The scan circuit 14 is a circuit that outputs the gate signal. As described with reference to FIGS. 2 and 3, the optical sensors WA coupled to the scan lines 6 and the signal lines 7 are arranged in a matrix having a row-column configuration in the detection area SA of the planar optical sensor 10. The scan line 6 is provided along the first direction Dx and is configured to transmit the gate signal that causes the optical sensors WA to generate the outputs. The signal line 7 is configured to transmit the outputs of the optical sensors WA along the second direction Dy.

The output of one PD 82 provided in one optical sensor WA corresponds to the intensity of the light detected by the PD 82 during the exposure period set in advance. The output of the PD 82 is reset in response to a signal supplied by the reset circuit 13 via the reset signal transmission line 5. When the signal turns on the gate of the switching element 81, the source and the drain of the switching element 81 are brought into a conducting state therebetween. This operation resets the potential of the coupling part CP to the reset potential VReset.

FIG. 4 illustrates schematic views illustrating configuration examples of the light source 22. As illustrated in FIG. 4, the light source 22 includes a first light source 22R, a second light source 22G, and a third light source 22B. The first light source 22R, the second light source 22G, and the third light source 22B emit light in different colors from one another. In the first embodiment, the first light source 22R emits red (R) light. The second light source 22G emits green (G) light. The third light source 22B emits blue (B) light.

As illustrated as “First Example” in FIG. 4, the light source 22 has, for example, a light-emitting area 2202 and a frame area 2201. In the light-emitting area 2202, the first light source 22R, the second light source 22G, and the third light source 22B that are square in shape in plan view are arranged along the second direction Dy. The frame area 2201 is a frame-like area surrounding the light-emitting area 2202. A width D1 in the first direction Dx of the light-emitting area 2202 is smaller than a width D2 in the first direction Dx of the frame area 2201. A height H1 in the second direction Dy of the light-emitting area 2202 is smaller than a height H2 in the second direction Dy of the frame area 2201. The distance between the first light source 22R and the second light source 22G is a distance H3, and the distance between the second light source 22G and the third light source 22B is also the distance H3. The distance H3 is less than half the height H1. In “First Example” in FIG. 4, the width D1 is equal to the height H1, and the width D2 is equal to the height H2, but at least one of the widths may differ from a corresponding one of the heights. The light source 22 may be replaced with a light source of another form, specifically, such as a light source 22A illustrated in “Second Example” in FIG. 4. In the light source 22A, the longitudinal directions of the first light source 22R, the second light source 22G, and the third light source 22B are along the second direction Dy, and the first light source 22R, the second light source 22G, and the third light source 22B are arranged in this order from one side toward the other side in the first direction Dx. First Example and Second Example in FIG. 4 are exemplary forms of the light source according to the present disclosure, which is not limited to these examples. The shapes of the first light source 22R, the second light source 22G, and the third light source 22B in plan view and the positional relation between the first light source 22R, the second light source 22G, and the third light source 22B can be changed as appropriate. The term “plan view” refers to a front view of a plane along the first direction Dx and the second direction Dy (Dx-Dy plane).

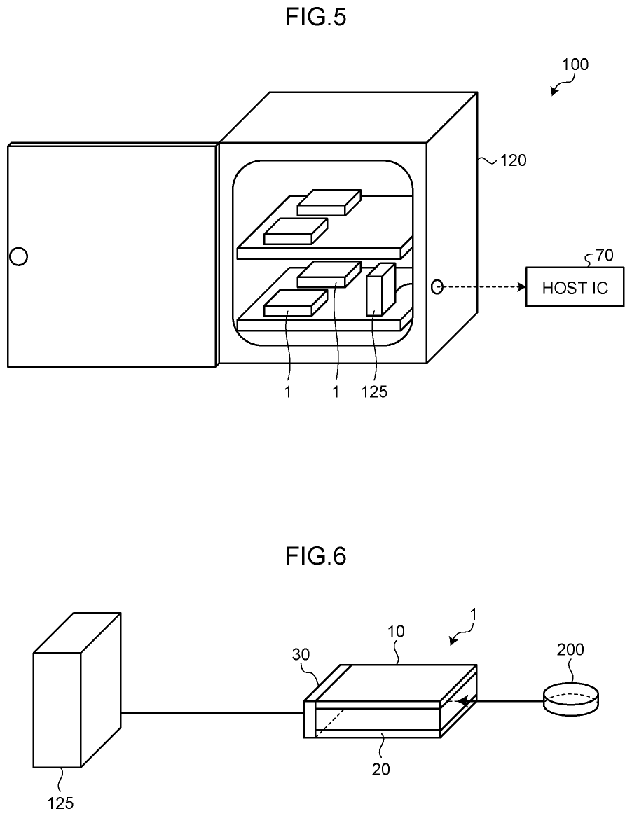

FIG. 5 is a schematic diagram schematically illustrating a configuration example of a detection system 100 including the detection device 1. As illustrated in FIG. 5, the detection system 100 includes a plurality of the detection devices 1, a host integrated circuit (IC) 70, and a coupling circuit 125. The detection devices 1 are electrically coupled to the common host IC 70 via the coupling circuit 125.

An incubator 120 illustrated in FIG. 5 is maintained such that an environment (temperature, humidity, and the like) therein is suitable for culturing biological samples on the object to be detected 200 while a door is closed. The detection devices 1 are placed in the incubator 120.

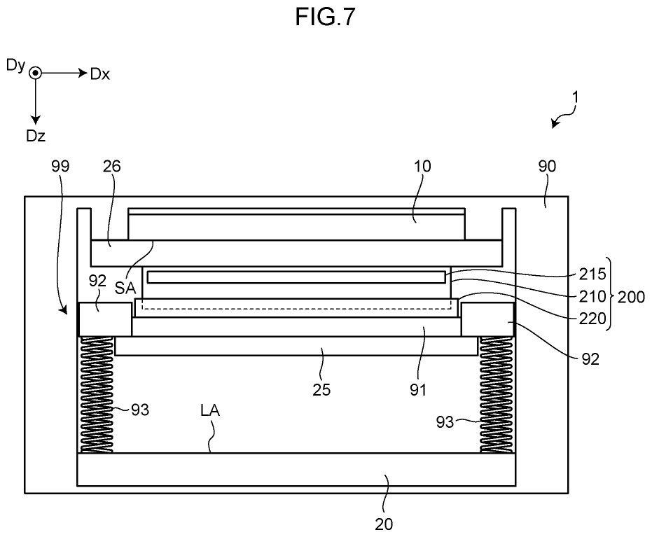

FIG. 6 is a schematic diagram illustrating a relation between one of the detection devices 1 and an external configuration. As illustrated in FIG. 6, the detection device 1 is coupled to the coupling circuit 125 by coupling the control circuit 30 to the coupling circuit 125. As illustrated in FIG. 6 and FIG. 7, which is to be described later, the planar optical sensor 10 faces the light source panel 20. The object to be detected 200 can be placed between the planar optical sensor 10 and the light source panel 20.

FIG. 6 only schematically illustrates a rough relation between the planar optical sensor 10, the light source panel 20, and the object to be detected 200. A specific structure for placing the object to be detected 200 between the planar optical sensor 10 and the light source panel 20 will be described with reference to FIG. 7.

FIG. 7 is a schematic view illustrating a structure of various parts including main components of the detection device 1 and the object to be detected 200 placed on the detection device 1. The object to be detected 200 is a culture medium 215 (e.g., agar) accommodated in a dish 210 of a container. The container further includes a lid 220. The dish 210 is specifically a Petri dish. The lid 220 is a cover of the dish 210. As illustrated in FIG. 7 and other drawings, the inner diameter of an annular sidewall of the lid 220 is equal to or more than the outer diameter of the annular sidewall of the dish 210. That is, the lid 220 has a cylindrical inner circumferential wall that covers a cylindrical outer circumferential wall of the dish 210 from the outside. The culture medium 215 is a culture medium capable of culturing the colonies. Hereinafter, the term simply called “colony” refers to a colony of samples cultured on the culture medium 215 formed on the object to be detected 200. The samples are biological samples, such as biological tissues or microorganisms, which are assumed to be cultured on the culture medium 215. The culture medium 215 exhibits a light-transmitting property with the degree of light transmission varying depending on the presence or absence of the colony and the thickness of the colony. The object to be detected 200 is placed on a light-transmitting member 91. The light-transmitting member 91 is a plate-like member made of colorless glass or a light-transmitting colorless synthetic resin.

The light-transmitting member 91 is a circular member having a diameter that can accommodate therein the object to be detected 200 in plan view. The light-transmitting member 91 has a light-transmitting area that can accommodate therein the object to be detected 200 between the planar optical sensor 10 and the light source panel 20. The light-transmitting member 91 is in contact with a light-blocking member 92 at the outer peripheral edge. The light-blocking member 92 is a plate-like member into which the light-transmitting member 91 is fitted. The light-blocking member 92 exhibits a light-blocking property.

In the first embodiment, a diffusion plate 25 is provided on the light source panel 20 side of the light-transmitting member 91. The diffusion plate 25 is an optical member that diffuses light. The diffusion plate 25 is located to be interposed between the light-transmitting member 91 and the light-emitting area LA of the light source panel 20. When the diffusion plate 25 receives the light emitted from the light-emitting area LA from the light source panel 20 side, the diffusion plate 25 further diffuses the traveling direction of the light as the light is transmitted toward the light-transmitting member 91. This diffusion can uniform, in plan view, the light from the light-emitting area LA formed by a set of the light sources 22 that are two-dimensionally arranged.

As illustrated in FIG. 7, in the first embodiment, an elastic member 93 is provided between the light-blocking member 92 and the light source panel 20. The elastic member 93 has elasticity to urge the light-blocking member 92 toward the planar optical sensor 10. Specifically, the elastic member 93 is a cylindrical compression coil spring, as illustrated, for example, in FIG. 7. The object to be detected 200 placed on the light-transmitting member 91 is pressed against a member 26 provided between the planar optical sensor 10 and the light-transmitting member 91 by an urging force applied to the light-blocking member 92 by the elastic member 93. In the first embodiment, an object placement member 99 is configured with the light-transmitting member 91, the light-blocking member 92, and the elastic member 93. In other words, the object placement member 99 includes the light-transmitting member 91 that is a light-transmitting member on which the object to be detected is placed, and the light-blocking member 92 that is a light-blocking member supporting the light-transmitting member from the outer periphery. The diameter of a circle of an edge 95, that is, a boundary between the light-transmitting member 91 and the light-blocking member 92, is larger than the diameter of a circle of the edge of the dish 210. That is, the culture medium 215 is positioned inside the edge 95.

The member 26 serves as an optical member that limits the light that is emitted from the light-emitting area LA of the light source panel 20 and reaches the planar optical sensor 10. Specifically, the member 26 includes any of a plate-shaped louver, cylindrical openings, and microlenses. In the plate-shaped louver, a plurality of plate-like structures with plate surfaces extending along the third direction Dz are arranged in parallel. The structures are preferably made of a material having a strong light-absorbing property. The member 26 is provided along a plane (Dx-Dy plane) orthogonal to the third direction Dz. The cylindrical openings penetrate the member 26 in the third direction Dz with respect to the base of the member 26. The base is preferably made of a material having a strong light-absorbing property. The microlenses are small lenses having an optical axis along the third direction Dz. The base of the member 26 that supports the microlenses is preferably made of a material having a strong light-absorbing property. Regardless of what shape the member 26 has, the member 26 as the optical member is provided in order to limit the traveling direction of the light emitted from the light sources 22 and reaching the planar optical sensor 10 to the third direction Dz or a direction having a shallower inclination angle with respect to the third direction Dz.

A housing 90 maintains a configuration in which the light-emitting area LA of the light source panel 20 and the detection area SA of the planar optical sensor 10 face in the third direction Dz. The housing 90 is a light-blocking housing provided so as to accommodate therein in advance the light source panel 20, the elastic member 93, the diffusion plate 25, the light-transmitting member 91, the light-blocking member 92, the member 26, and the planar optical sensor 10. Placing the object to be detected 200 between the member 26 and the light-transmitting member 91 establishes the positional relation among the components illustrated in FIG. 7. In the first embodiment, the object to be detected 200 is placed on the light-transmitting member 91 so that the lid 220 side of the object to be detected 200 contacts the light-transmitting member 91. That is, the object to be detected 200 is placed between the planar optical sensor 10 and the light source panel 20 such that the lid 220 is located relatively below and the dish 210 is located relatively above.

As described above with reference to FIG. 7, the detection device 1 of the first embodiment has a structure that allows the object to be detected 200 to be placed so as to be interposed between the planar optical sensor 10 and the light source panel 20. In the placed object to be detected 200, the bottom surface of the dish 210 with the culture medium 215 provided therein extends along the detection area SA of the planar optical sensor 10 and the light-emitting area LA of the light source panel 20.

The light emitted from the light-emitting area LA of the light source panel 20 is diffused by the diffusion plate 25, passes through the light-transmitting member 91, the object to be detected 200, and the member 26, and reaches the detection area SA of the planar optical sensor 10. Thus, the planar optical sensor 10 can be said to be configured to produce an output reflecting the intensity of light that has been emitted from the light sources 22 and reached the optical sensors WA through the object to be detected 200. The data herein is data based on a set of the outputs from the optical sensors WA, and is, for example, an image to be described later. The intensity of the light reaching the detection area SA is affected by the degree of light transmission depending on the position of the object to be detected 200 placed on the light-transmitting member 91, the state of the culture medium 215 provided in the object to be detected 200, and objects placed on the culture medium 215.

As described with reference to FIG. 2, the optical sensors WA are two-dimensionally arranged along the Dx-Dy plane. Therefore, the data based on the set of the outputs from the optical sensors WA can be regarded as data of a two-dimensional image. Hereinafter, the term “image” refers to an image generated from the set of the outputs from the optical sensors WA, unless otherwise noted.

The positional relation in plan view between the planar optical sensor 10, the light-transmitting member 91, and the light-blocking member 92 is substantially determined by the housing 90. Therefore, the positions of the light-transmitting member 91 and the light-blocking member 92 and the position of the edge 95 included in the image are substantially fixed.

In contrast, the position of the object to be detected 200 placed on the light-transmitting member 91 in plan view depends on where the object to be detected 200 is placed at the start. The position of the object to be detected 200 may also be changed by vibration or other disturbances externally applied to the detection device 1.

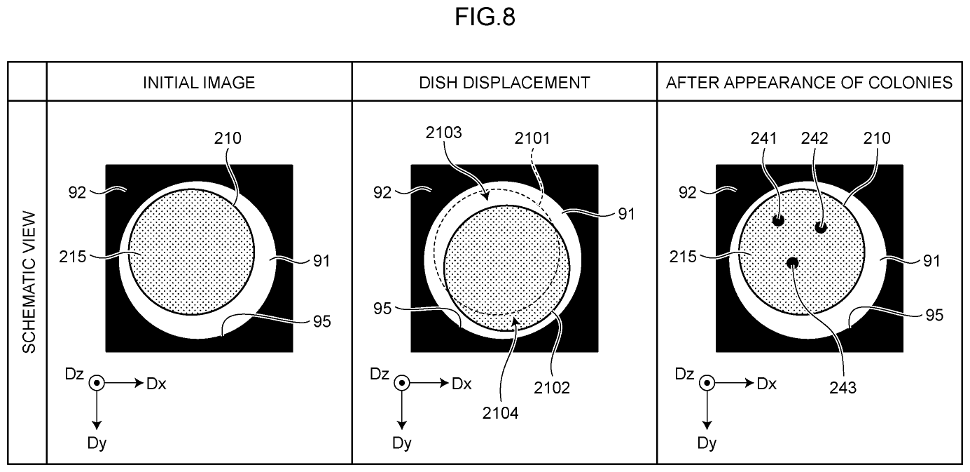

FIG. 8 illustrates schematic views illustrating examples of images obtained in the first embodiment. For the purpose of more clearly illustrating the dish 210 and the culture medium 215, FIG. 8 illustrates simplified images by intentionally omitting the lid 220 from the object to be detected 200. In a column titled “initial image”, an image immediately after the object to be detected 200 is placed on the light-transmitting member 91 is illustrated. No colonies are formed yet on the culture medium 215 in the object to be detected 200 immediately after being placed on the light-transmitting member 91. In a column titled “dish displacement”, an image is illustrated that is obtained in a state where the position of the object to be detected 200 has changed on the light-transmitting member 91 after the “initial image” is obtained. In a column titled “after appearance of colonies”, an image is illustrated that is obtained in a state where, after “initial image” has been obtained, the samples to be cultured have grown to form colonies 241, 242, and 243 on the culture medium 215.

For example, in terms of the positional relation of the dish 210 relative to the edge 95 illustrated in FIG. 8, the positional relation illustrated in the column titled “initial image” differs from the positional relation illustrated in the column titled “dish displacement”. This is because the image in the column titled “dish displacement” is obtained after the position of the object to be detected 200 has been changed by the vibration or other disturbances externally applied to the detection device 1 after the acquisition of the image in the column titled “initial image”. In the column titled “dish displacement”, a circle 2101 indicates a position of the dish 210 (position before change) in the column titled “initial image”, and a circle 2102 indicates a position thereof after having changed.

The formation state of the colonies illustrated in the column titled “initial image” differs from the formation state of the colonies illustrated in the column titled “after appearance of colonies”. This is because the image in the column titled “after appearance of colonies” has been obtained after the samples have grown on the culture medium 215 and form the colonies after the image in the column titled “initial image” was obtained.

The detection device 1 of the first embodiment repeats an operation to obtain a new image each time at a predetermined amount of time interval starting from a starting point when the initial image is obtained. The time when the initial image is obtained is immediately after the object to be detected 200 is placed on the light-transmitting member 91, and at this time, no colonies have formed on the culture medium 215. The image in the column titled “initial image” illustrated in FIG. 8 is an example of the image obtained at the first time regarded as the starting point. If the position of the object to be detected 200 has changed at the time when the image is obtained after one or more predetermined amount of time intervals have elapsed from the starting point, the obtained image is the image illustrated in the column titled “dish displacement”, for example. If colonies have formed at the time when the image is obtained after one or more predetermined amount of time intervals have elapsed from the starting point, the obtained image is the image illustrated in the column titled “after appearance of colonies”, for example.

The determination of whether colonies have formed on the culture medium 215 is made based on changes in the outputs of the optical sensors WA. Specifically, when a transition is made from the state where the image illustrated in the column titled “initial image” is obtained to the state where the image illustrated in the column titled “after appearance of colonies” is obtained, the outputs of the optical sensors WA overlapping the colonies 241, 242, and 243 in plan view significantly change. In the first embodiment, the determination of whether colonies have formed is made based on such changes in the outputs of the optical sensors WA.

However, the outputs of the optical sensors WA are also changed by the change in the position of the object to be detected 200. Specifically, if a transition is made from the state where the image illustrated in the column titled “initial image” is obtained to the state where the image illustrated in the column titled “dish displacement” is obtained, the outputs of the optical sensors WA overlapping a first area 2103 or a second area 2104 in plan view significantly change. The first area 2103 is an area within the circle 2101 in the image illustrated in the column titled “dish displacement”, and is an area that does not overlap the circle 2102. In the first area 2103, the degree of light transmission is reduced by the object to be detected 200 before the position of the object to be detected 200 changes. After the position of the object to be detected 200 changes, the reduction in light transmission caused by the object to be detected 200 disappears, whereby the outputs of the optical sensors WA become larger. The second area 2104 is an area within the circle 2102 in the image illustrated in the column titled “dish displacement”, and is an area that does not overlap the circle 2101. In the second area 2104, the degree of light transmission is not reduced by the object to be detected 200 before the position of the object to be detected 200 changes. After the position of the object to be detected 200 changes, light transmission is reduced by the object to be detected 200, whereby the outputs of the optical sensors WA become smaller.

As described above, the outputs of the optical sensors WA are changed either due to the formation of the colonies or the change in the position of the object to be detected 200. Therefore, merely simply detecting the change in the outputs of the optical sensors WA is not enough to determine whether the colonies have formed or the position of the object to be detected 200 has changed. Therefore, in the first embodiment, a process is performed to determine whether the colonies have formed or the position of the object to be detected 200 has changed. Specifically, whether the position of the object to be detected 200 has changed or the colonies have formed can be determined based on a change in overall magnitude of the outputs of all the optical sensors WA forming the image.

When the position of the object to be detected 200 changes, the outputs of the optical sensors WA become larger in the first area 2103, while the outputs of the optical sensors WA become smaller in the second area 2104. The degree of increase in the outputs of the optical sensors WA in the first area 2103 is substantially equal to the degree of decrease in the outputs of the optical sensors WA in the second area 2104. Thus, when evaluating all the outputs of the optical sensors WA forming the image, the magnitude of the outputs of the optical sensors WA forming the image illustrated in the column titled “initial image” is substantially the same as the magnitude of the outputs of the optical sensors WA forming the image illustrated in the column titled “dish displacement”. Even if the magnitudes are not the same, the difference between the magnitude of the outputs of the optical sensors WA forming the image illustrated in the column titled “initial image” and the magnitude of the outputs of the optical sensors WA forming the image illustrated in the column titled “dish displacement” is very small, or the magnitudes are substantially the same.

In contrast, when the colonies have formed, the degree of light transmission significantly decreases in areas where the colonies, such as the colonies 241, 242, and 243, have appeared. Thus, when evaluating all the outputs of the optical sensors WA forming the image, the magnitude of the outputs of the optical sensors WA forming the image illustrated in the column titled “after appearance of colonies” is significantly smaller than the magnitude of the outputs of the optical sensors WA forming the image illustrated in the column titled “initial image”.

Based on these phenomena, in the first embodiment, a process to determine whether the colonies have formed or the position of the object to be detected 200 has changed is performed by evaluating the outputs of the optical sensors WA using two thresholds: a first threshold and a second threshold. Specifically, the magnitude of the output of each of the optical sensors WA and the overall magnitude of the outputs of the optical sensors WA at a point of time when the image illustrated in the column titled “initial image” is obtained are used as references. In the process, the outputs of the optical sensors WA forming a new image obtained after one or more predetermined amount of time intervals have elapsed from the point of time are respectively compared with the outputs of the optical sensors WA each of which serves as a reference. The outputs thus compared are outputs from the same optical sensor WA. That is, in the process, the comparison is made to determine whether an output of a certain one of the optical sensors WA has been changed from the reference after the lapse of one or more predetermined amount of time intervals. The comparison is individually made for each of the outputs of the optical sensors WA. In this comparison, the first threshold is used as a threshold for determining the degree of change in the output.

The first threshold is a threshold for detecting changes in the outputs of the optical sensors WA that overlap colonies, such as the colonies 241, 242, and 243, in plan view. That is, when a transition is made from the state where the image illustrated in the column titled “initial image” is obtained to the state where the image illustrated in the column titled “after appearance of colonies” is obtained, a change in output exceeding the first threshold with respect to the reference occurs at each of the optical sensors WA that overlap the colonies 241, 242, and 243 in plan view. The first threshold is set in advance so that the change in output can be detected.

The change in output exceeding the first threshold can also occur due to the change in the position of the object to be detected 200, as in the first area 2103 and the second area 2104. Therefore, in the first embodiment, the overall magnitude of the outputs of all the optical sensors WA forming the new image is further compared with the overall magnitude of the outputs of all the optical sensors WA that serves as the reference. In this comparison, the second threshold is used as a threshold for determining the degree of change in the overall output of all the optical sensors WA.

The second threshold is a threshold for determining whether the change in the overall output of all the optical sensors WA is a change caused by colonies, such as the colonies 241, 242, and 243. As described above, when evaluating the overall output of the optical sensors WA forming the image, the overall magnitude of the outputs of the optical sensors WA forming the image illustrated in the column titled “after appearance of colonies” is significantly smaller than the overall magnitude of the outputs of the optical sensors WA forming the image illustrated in the column titled “initial image”. The second threshold is set in advance so that a significant decrease in the overall magnitude of the outputs of the optical sensors WA can be detected. Therefore, when any of the optical sensors WA has the above-described change in output exceeding the first threshold, and when the change in the overall output of the optical sensors WA exceeds the second threshold, it can be determined that colonies have formed.

In contrast, when the overall magnitude of the outputs of the optical sensors WA forming the image is evaluated, the overall magnitude of the outputs of the optical sensors WA forming the image illustrated in the column titled “initial image” is substantially the same as the overall magnitude of the outputs of the optical sensors WA forming the image illustrated in the column titled “dish displacement”. Therefore, even if any of the optical sensors WA has the above-described change in output exceeding the first threshold, if the change in the overall output of the optical sensors WA does not exceed the second threshold, it can be determined that the position of the object to be detected 200 has changed. With the above-described mechanism, in the first embodiment, the process is performed to determine whether the colonies have formed or the position of the object to be detected 200 has changed.

In the first embodiment, the control circuit 30 performs the process to determine whether the position of the object to be detected 200 has changed. Therefore, in the first embodiment, the control circuit 30 determines that the position of the object to be detected 200 has changed, when a first condition and a second condition are satisfied. The first condition is that, for each of one or more optical sensors WA, the difference between its outputs obtained at two time points separated by a predetermined amount of time or longer exceeds the first threshold. The second condition is that the difference between two overall outputs of the entire planar optical sensor 10 obtained at the two time points separated by the predetermined amount of time or longer does not exceed the second threshold. That is, in the first embodiment, the first threshold corresponds to a first predetermined value, and the second threshold corresponds to a second predetermined value. In the first embodiment, the control circuit 30 determines that the colonies have formed on the culture medium 215 when the first condition and a third condition are satisfied. The third condition is that the difference between the two overall outputs of the entire planar optical sensor 10 obtained at the two time points exceeds the second threshold.

In other words, the first condition is that, for at least one of the optical sensors WA in the planar optical sensor 10, the difference between the output of the optical sensor WA obtained at a first timing and the output of the optical sensor WA obtained at a second timing exceeds the first threshold. The second condition is that the difference between the overall output of the entire planar optical sensor 10 obtained at the first timing and the overall output of the entire planar optical sensor 10 obtained at the second timing does not exceed the first threshold. The third condition is that the difference between the overall output of the entire planar optical sensor 10 obtained at the first timing and the overall output of the entire planar optical sensor 10 obtained at the second timing exceeds the first threshold. The second timing is at least a predetermined amount of time after the first timing. The “overall output of the entire planar optical sensor 10” is the sum of the outputs of all the optical sensors WA included in the entire planar optical sensor 10.

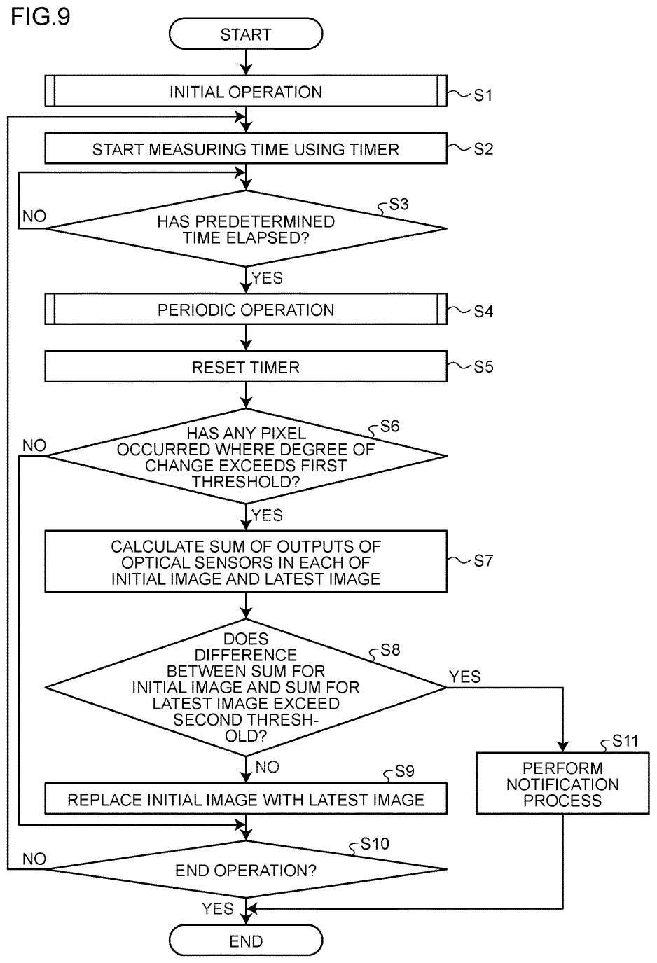

The following describes a process related to the operations of the detection device 1 with reference to flowcharts in FIGS. 9 to 11. Unless otherwise noted, in the first embodiment, each step illustrated in the flowcharts in FIGS. 9 to 11 is mainly executed by the control circuit 30.

FIG. 9 is a flowchart of processing related to the operations of the detection device 1. First, an initial operation is performed (Step S1). At the time of an initial process, the initial operation is performed immediately after the object to be detected 200 is placed on the detection device 1. That is, at the time of the initial process, no colonies have been formed on the culture medium 215.

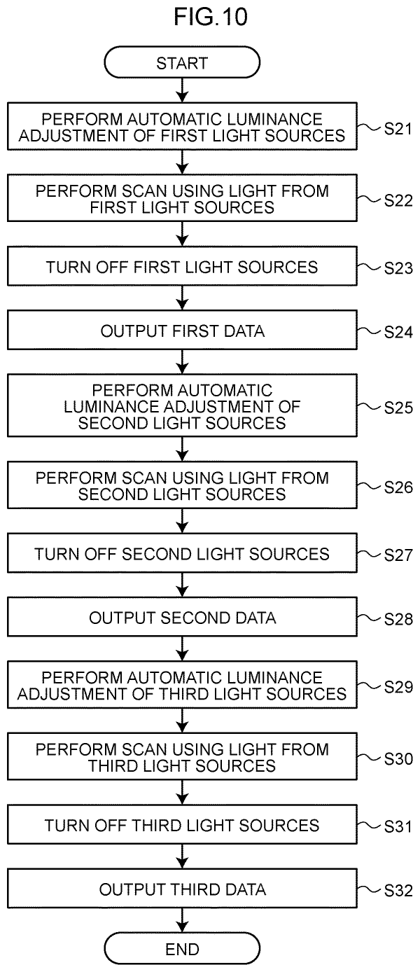

FIG. 10 is a flowchart of the initial process. First, automatic luminance adjustment of the first light sources 22R is performed (Step S21). The automatic luminance adjustment in each of the operations at Step S21 and at Steps S25 and S29 to be described later is a process to adjust the luminance of a plurality of light sources for the same color provided in the light-emitting area LA to pre-assumed luminance. The following describes an exemplary case in which the automatic luminance adjustment of a plurality of the first light sources 22R is performed in the processing at Step S21. In this example, the operation is controlled such that the first light sources 22R start operating at either the lowest luminance or the highest luminance and change in luminance toward the other of the lowest luminance and the highest luminance with the lapse of time. During the lapse of the time, the detection of the light using the optical sensors WA provided in the detection area SA and the output from the optical sensors WA are periodically performed. The luminance of the first light sources 22R is regarded as the pre-assumed luminance when the outputs of the optical sensors WA becomes outputs corresponding to the pre-assumed luminance.

In the processing at Step S21 in the first embodiment, the luminance of the first light sources 22R is adjusted individually. Specifically, the optical sensors WA are associated with the first light sources 22R in advance. This association is related to the relation between the output of each optical sensor WA and the brightness of each first light source 22R. With this association, when one optical sensor WA has produced an output corresponding to a pre-assumed luminance, the first light source 22R associated with the one optical sensor WA is determined to have the pre-assumed luminance. More specifically, each of the optical sensors WA detects light from the first light source 22R associated with the optical sensor WA more strongly than light from the other first light sources 22R. That is, the first light sources 22R and the optical sensors WA associated with each other are arranged so as to overlap or substantially overlap each other in plan view. The luminance of the first light source 22R is determined in this way, thus completing the automatic luminance adjustment.

In the processing at each of Step S21 and Steps S25 and S29 to be described later, the control circuit 30 operates the planar optical sensor 10 and the light source panel 20 to perform the automatic luminance adjustment.

The description of processing at Step S25 to be described later is obtained by replacing the first light sources 22R in the description of the processing at Step S21 with the second light sources 22G. The description of processing at Step S29 to be described later is obtained by replacing the first light sources 22R in the description of the processing at Step S21 with the third light sources 22B. The specific process of the automatic luminance adjustment illustrated herein is only an example and is not limited to this example. The details may be changed as appropriate as long as the luminance of the multiple light sources for the same color can be set to the pre-assumed luminance as a result.

After the processing at Step S21, a scan using the light from the first light sources 22R is performed (Step S22). Specifically, the scan is performed by the control circuit 30 operating the planar optical sensor 10 and the light source panel 20. In the processing at Step S22, the light sources turned on by the operation of the light source panel 20 are the first light sources 22R. The second light sources 22G and the third light sources 22B are not turned on in the processing at Step S22. As a result, the control circuit 30 obtains an image corresponding to the outputs of the optical sensors WA that have detected the light emitted from the first light sources 22R and transmitted through the object to be detected 200. At the completion of the processing at Step S22, the first light sources 22R are turned off (Step S23).

In the processing at Step S26 to be described later, the light sources to be turned on are not the first light sources 22R, but the second light sources 22G. In the processing at Step S30 to be described later, the light sources to be turned on are not the first light sources 22R, but the third light sources 22B.

After the processes at Steps S22 and S23, first data is output (Step S24). The first data is data of the image obtained by the light from the first light sources 22R.

After the processing at Step S24, the automatic luminance adjustment of the second light sources 22G is performed (Step S25). After the processing at Step S25, the scan using the light from the second light sources 22G is performed (Step S26). Specifically, the scan is performed by the control circuit 30 operating the planar optical sensor 10 and the light source panel 20. In the processing at Step S26, the light sources turned on by the operation of the light source panel 20 are the second light sources 22G. The first light sources 22R and the third light sources 22B are not turned on in the processing at Step S26. As a result, the control circuit 30 obtains an image corresponding to the outputs of the optical sensors WA that have detected the light from the second light sources 22G transmitted through the object to be detected 200. At the completion of the processing at Step S26, the second light sources 22G are turned off (Step S27).

After the processing at Steps S26 and S27, second data is output (Step S28). The second data is data of the image obtained by the light from the second light sources 22G.

After the processing at Step S28, the automatic luminance adjustment of the third light sources 22B is performed (Step S29). After the processing at Step S29, the scan using the light from the third light sources 22B is performed (Step S30). Specifically, the scan is performed by the control circuit 30 operating the planar optical sensor 10 and the light source panel 20. In the processing at Step S30, the light sources turned on by the operation of the light source panel 20 are the third light sources 22B. The first light sources 22R and the second light sources 22G are not turned on in the processing at Step S30. As a result, the control circuit 30 obtains an image corresponding to the outputs of the optical sensors WA that have detected the light from the third light sources 22B transmitted through the object to be detected 200. At the completion of the processing at Step S30, the third light sources 22B are turned off (Step S31).

After the processing at Steps S30 and S31, third data is output (Step S32). The third data is data of the image obtained by the light from the third light sources 22B.

The initial operation ends with the completion of the first execution of Step S32. As illustrated in FIG. 9, after the initial operation that is the processing at Step S1, a timer starts measuring time (Step S2). The processing at Step S2 may be performed, for example, by a timer circuit provided in the control circuit 30, by setting a variable that serves as a counter and updating the counter based on an operating clock of the control circuit 30, or by other methods.

After the start of measuring time by the processing at Step S2, a check is made to determine whether a predetermined amount of time has elapsed (Step S3). Until the predetermined amount of time elapses, the control circuit 30 waits (No at Step S3), without performing the next processing. The predetermined amount of time is five minutes, for example, but is not limited thereto. The predetermined amount of time may be determined as appropriate according to a cycle (time interval) at which determination of whether colonies have been formed is to be made. When the predetermined amount of time has elapsed after the processing at Step S1 (Yes at Step S3), a periodic operation is performed (Step S4).

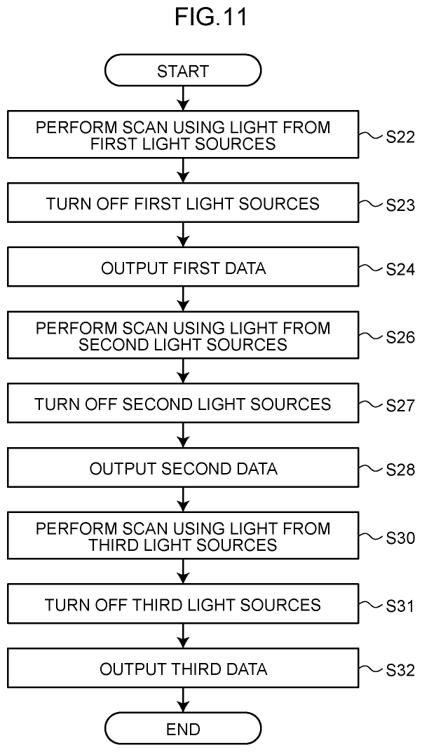

FIG. 11 is a flowchart of the periodic operation. The periodic operation is an operation in which the operations at Steps S21, S25, and S29 are omitted from the operations included in the initial operation described with reference to FIG. 10. In the periodic operation, the process is performed in the following order: Step S22, Step S23, Step S24, Step S26, Step S27, Step S28, Step S30, Step S31, and Step S32.

The first light sources 22R, the second light sources 22G, and the third light sources 22B are turned on at different times. While one group of a group of the first light sources 22R, a group of the second light sources 22G, and a group of the third light sources 22B is on, the other two groups are not on. These light sources are periodically turned on in the order of the first light sources 22R, the second light sources 22G, and the third light sources 22B. These operations are indicated by Steps S22, S23, S26, S27, S30, and S31 in the initial operation and the periodic operation.

The luminance of the first light sources 22R that are turned on in the periodic operation is the luminance adjusted by the automatic luminance adjustment by the processing at Step S21 in the initial operation. The luminance of the second light sources 22G that are turned on in the periodic operation is the luminance adjusted by the automatic luminance adjustment by the processing at Step S25 in the initial operation. The luminance of the third light sources 22B that are turned on in the periodic operation is the luminance adjusted by the automatic luminance adjustment by the processing at Step S29 in the initial operation.

When the second and subsequent executions of step S32 are completed, the periodic operation ends. As illustrated in FIG. 9, after the periodic operation that is the processing at Step S4, the timer is reset (Step S5). That is, the timer that started timing at Step S2 is reset in the processing at Step S5.

The control circuit 30 determines whether any pixel has occurred where the degree of change in output between the initial image and the latest image exceeds the first threshold (Step S6). The term “pixel” herein refers to a pixel included in an image when the set of all the outputs of the optical sensors WA is regarded as the image. That is, the term “pixel” herein refers to any of the outputs of the optical sensors WA. The term “initial image” herein is the first, the second, and the third data obtained in the processing at Step S1 until processing at Step S9 to be described later is executed. The term “latest image” herein refers to the first data, the second data, and the third data obtained in the latest execution of Step S4. In the processing at Step S6, the first data of the initial image is compared with the first data of the latest image; the second data of the initial image is compared with the second data of the latest image; and the third data of the initial image is compared with the third data of the latest image.

If, in the processing at Step S6, a pixel is determined to have occurred where the degree of change in output exceeds the first threshold (Yes at Step S6), the control circuit 30 calculates the sum of the outputs of the optical sensors WA in each of the initial image and the latest image (Step S7). The sum is calculated to compare the difference between the overall magnitude of the outputs of the optical sensors WA forming the initial image and the overall magnitude of the outputs of the optical sensors WA forming the latest image with the second threshold mentioned above. That is, the sum for the initial image represents the overall magnitude of the outputs of all the optical sensors WA forming the initial image. The sum for the latest image represents the overall magnitude of the outputs of all the optical sensors WA forming the latest image.

After the processing at Step S7, the control circuit 30 determines whether the difference between the sum for the initial image and the sum for the latest image exceeds the second threshold (Step S8). If, in the processing at Step S8, it is determined that the difference between the sum for the initial image and the sum for the latest image does not exceed the second threshold (No at Step S8), the control circuit 30 replaces the initial image with the latest image (Step S9).

The determination that the difference between the sum for the initial image and the sum for the latest image does not exceed the second threshold is equivalent to the determination that a change in the position of the object to be detected 200 has occurred as described above. Therefore, if the initial image is left as it is without being replaced, the latest image obtained thereafter continues to be determined to be an image in which the position of the object to be detected 200 has changed relative to the initial image. Therefore, in the first embodiment, the initial image is replaced with the latest image if it is determined that the difference between the sum for the initial image and the sum for the latest image does not exceed the second threshold. This replacement establishes a state in which there should be no difference in the position of the object to be detected 200 between the latest image obtained thereafter and the initial image after the replacement.

In the initial operation at Step S1 and the periodic operation at Step S4, the first data, the second data, and the third data are generated. In the processing at Step S9 in the first embodiment, the initial image is replaced with the latest image for all of the first data, the second data, and the third data.

If, after the processing at Step S9 or in the processing at Step S6, it is determined that there are no pixel that have changed in output exceeding the first threshold (No at Step S6), the process returns to the processing at Step S2 unless the operation of the detection device 1 is ended (No at Step S10). That is, the timer starts measuring time again, and the process related to the periodic operation and the resetting of the timer is performed at intervals of the predetermined amount of time.

If the processing at Step S8 determines that the difference between the sum for the initial image and the sum for the latest image exceeds the second threshold (Yes at Step S8), a notification process is performed (Step S11). The determination that the difference between the sum for the initial image and the sum for the latest image exceeds the second threshold is equivalent to the determination that the samples to be cultured have grown on the culture medium 215 to generate the colonies as described above. The notification process is a process to give a notification that the colonies have formed. In the notification process, a predetermined notification method is used to perform the notification. In the first embodiment, the notification process is performed to send an electronic mail indicating the formation of the colonies to an electronic mail address of a manager of the object to be detected 200. The electronic mail and a text to be sent via the electronic mail are determined in advance. In the first embodiment, for example, the control circuit 30 serves as a sender of the electronic mail, but is not limited to this example. As another example, the control circuit 30 may output, to an external information processing device, a signal that serves as an instruction for the external information processing device to send the electronic mail, or may use other methods. The way of the notification used in the notification process is not limited to the sending of the electronic mail. For example, a voice output device such as a speaker may be operated to output predetermined “voice to notify that colonies has been formed”, or other ways of notification may be used.

If the operation of the detection device 1 is ended after the processing at Step S11 or in the processing at Step S10 (Yes at Step S10), the process related to the operations of the detection device 1 ends.

As described above, according to the first embodiment, the detection device 1 includes the light sources (light sources 22) that emit light, the planar optical sensor (planar optical sensor 10) in which the optical sensors (optical sensors WA) that detect the light from the light sources are two-dimensionally arranged, the object placement member (object placement member 99) that is provided so as to allow the object to be detected (object to be detected 200) to be placed such that the object to be detected is interposed between the light sources and the planar optical sensor, and the processor (control circuit 30) that performs the operation control of the light sources and the planar optical sensor and the processing based on the outputs of the optical sensors. The object to be detected is the culture medium (culture medium 215) accommodated in the dish (dish 210) of the container. The processor is configured to obtain two outputs from each of the optical sensors WA included in the planar optical sensor 10 with an interval of a predetermined amount of time or longer. If, for each of one or more of the optical sensors WA, the difference between the two outputs of the optical sensor exceeds the first predetermined value (first threshold), and if the difference between two overall outputs of the planar optical sensor does not exceed the second predetermined value (second threshold), the processor determines that the position of the object to be detected has changed. Therefore, the change in the output of the planar optical sensor due to the displacement of the dish can be determined to be a change different from the change in the output of the planar optical sensor due to the formation of the colonies on the culture medium.

According to the first embodiment, if, for one or more of the optical sensors (optical sensors WA), the difference between the two outputs of each optical sensor included in the outputs of the planar optical sensor (planar optical sensor 10) obtained with an interval of the predetermined amount of time or longer exceeds the first predetermined value (first threshold), and if the difference between the two overall outputs of the planar optical sensor exceeds the second predetermined value (second threshold), the samples to be cultured on the culture medium (culture medium 215) are determined to have grown to generate the colonies on the culture medium. Therefore, the colonies can be detected with a high degree of accuracy after distinguishing the change in position of the object to be detected (object to be detected 200) from the formation of the colonies.

### Second Embodiment

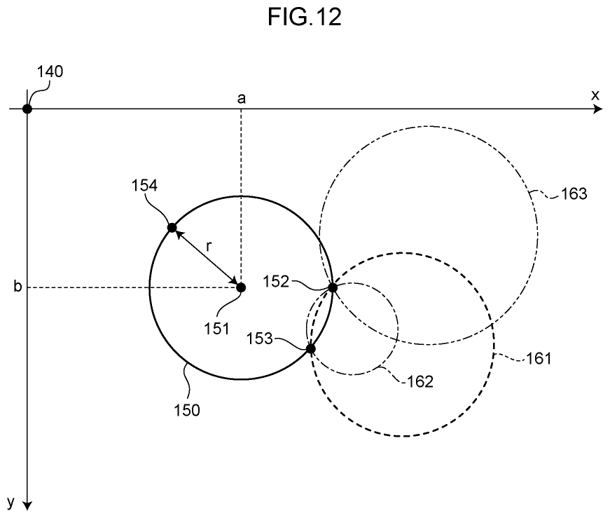

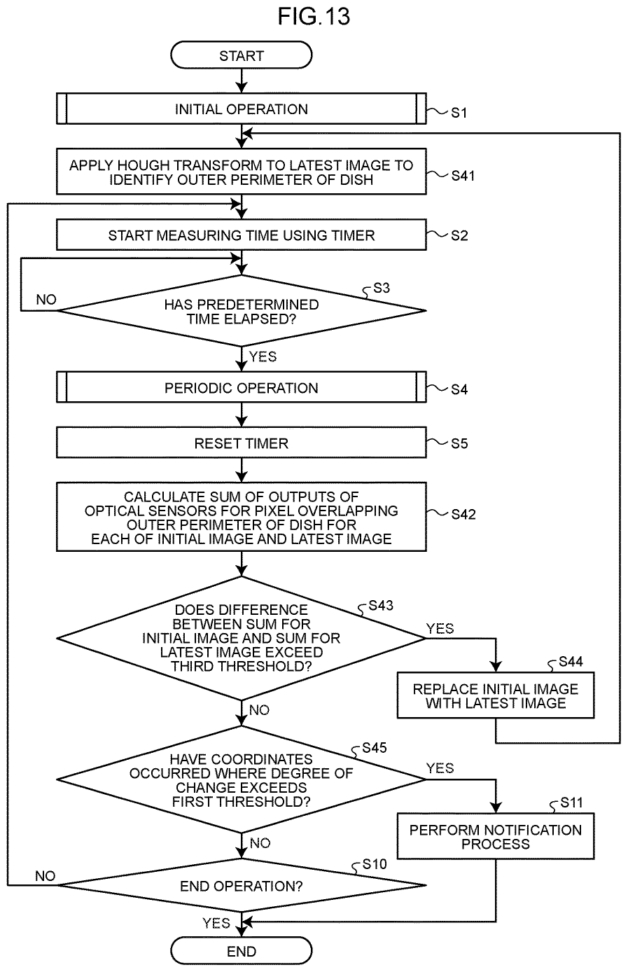

With reference to FIGS. 12 and 13, the following describes a second embodiment of the present disclosure in which a part of the flow of the process related to the operations of the detection device 1 differs from that of the first embodiment. In the description of the second embodiment, the same items as those in the first embodiment are denoted by the same reference numerals, and will not be described again.

The second embodiment differs from the first embodiment in specific details of the process to determine whether the colonies have formed or the position of the object to be detected 200 has changed. In the second embodiment, a processing is first performed to identify a circumference that is regarded as the outer perimeter of the dish 210. Specifically, the processing to apply the Hough transform is performed as the processing to identify the circumference regarded as the outer perimeter of the dish 210.

FIG. 12 is a diagram explaining the Hough transform. The description with reference to FIG. 12 assumes a case to extract a circle 150 having a radius r and centered on a point 151 in a two-dimensional space of an x-y plane having the origin at a point 140. Points 152, 153, and 154 are points located on the circumference of the circle 150.

For example, a circle having a circumference overlapping the point 152 is not limited to the circle 150; there exist countless such circles, such as circles 161, 162, and 163. Therefore, when trying to obtain a circle having a circumference overlapping the point 152, countless circles can be obtained as candidates. The circumferences of the circles 150, 161, and 162 overlap the point 153, but the circumference of the circle 163 does not overlap the point 153. Therefore, by limiting the condition for the circle to be obtained to “the circumference overlaps the points 152 and 153”, it is possible to exclude circles, such as the circle 163, having circumferences not overlapping the point 153 from the candidates of the circle to be obtained. The circumference of the circle 150 overlaps the point 154, but the circumferences of the circles 161 and 162 do not overlap the point 154. Therefore, by limiting the condition for the circle to be obtained to “the circumference overlaps the points 152, 153, and 154”, the circle to be obtained can be limited to the circle 150. In other words, through the Hough transform, the circle 150 is extracted as a “more probable circle” that has a circumference passing through a plurality of points (such as the points 152, 153, and 154) through which the circumference of the circle to be obtained passes, with higher priority than other circles, such as the circles 161, 162, and 163.

As described with reference to FIG. 12, the Hough transform used in the present embodiment is used to extract a circle having a circumference that overlaps a plurality of points. Specifically, the Hough transform extracts a circle represented by three values (a, b, r). Of these values, “a” and “b” indicate a coordinate in an x-direction and a coordinate in a y-direction in a coordinate system of x and y with respect to the origin (such as the point 140). That is, the coordinates can be expressed as (x, y)=(a, b). In FIG. 12, the coordinates expressed by (x, y)=(a, b) are the coordinates of the point 151. “r” indicates the radius r of a circle having the circle center at coordinates expressed as (x, y)=(a, b). Any point (x, y)=(X, Y) on the circumference extracted by the Hough transform can be expressed by Expression (1) below.

r²=(X−a)²+(Y−b)² (1)

The extraction of the multiple points, such as the points 152, 153, and 154 in FIG. 12, which overlap the circumference of the circle extracted by the Hough transform is performed using image processing such as an outline extraction. Specifically, the set of the outputs from the optical sensors WA is regarded as an image. The image herein is obtained by regarding an output of one optical sensor WA as one pixel and arranging a plurality of the pixels so as to correspond to the arrangement of the optical sensors WA in the detection area SA. Hereinafter, the term simply called “image” refers to the set of the outputs of the optical sensors WA, unless otherwise noted. The term simply called “pixel” refers to the output of the optical sensor WA, unless otherwise noted. In practice, a processing such as an analog-to-digital conversion is performed to regard the output of the optical sensor WA as the pixel. This processing is performed by the detection circuit 15 in the present embodiment as described above, but may be performed by the control circuit 30.

In the present embodiment, the outline extraction is performed on the image to extract a plurality of outlines. The outlines include an outline indicating the annular outer peripheral wall of the dish 210, an outline indicating the annular outer peripheral wall of the lid 220, and an outline indicating the edge 95. Each of these outlines is constituted by a plurality of annularly arranged points. Three or more of the points are arranged correspondingly to the radius r centered on the point 151, as in the case of, for example, the points 152, 153, and 154 in FIG. 12. Thus, one circle such as the circle 150 can be extracted by the Hough transform. After the outline extraction, the Hough transform is applied to individually obtain a, b, and r for each of the outlines, and the circumference of the circle represented by the three values a, b, and r is extracted.

In the present embodiment, a1, b1, and r1 that indicate the circumference corresponding to the outer peripheral wall of the dish 210, a2, b2, and r2 that indicate the circumference corresponding to the outer peripheral wall of the lid 220, and a3, b3, and r3 that indicate the circumference corresponding to the edge 95 are individually obtained. a1, a2, and a3 each indicate the value of “a”. b1, b2, and b3 each indicate the value of “b”. r1, r2, and r3 each indicate the value of “r”.

The object to be detected 200 is provided to fit inside the edge 95. That is, the outer diameter of the object to be detected 200 is less than the diameter of the edge 95. The inside diameter of the lid 220 is larger than the outside diameter of the dish 210. These facts indicate that the circumference corresponding to the outer perimeter of the dish 210 is the innermost circumference that is relatively the smallest of the circumferences extracted by the Hough transform. In the present embodiment, the innermost circumference that is relatively the smallest of the circumferences extracted by the Hough transform is regarded as the outer perimeter of the dish 210.

In most cases, the points forming an outline that can be regarded as one circle include a significantly greater number of points than three points. The outline extraction is an image binarization process, such as the application of a Gaussian filter, but is not limited to this processing, and may be any other image processing that can extract the outline included in the image. Additional image processing, such as application of a noise filter, may be further performed between the outline extraction and the Hough transform to obtain the outline more accurately.

In the present embodiment, the various types of processes such as the outline extraction, the Hough transform, and the additional image processing are performed by the control circuit 30, but the present disclosure is not limited to this configuration. For example, a dedicated configuration for various extraction processes may be separately provided.

The identification of the circumference that is regarded as the outer perimeter of the dish 210 is performed on either the initial image or the latest image in the second embodiment. In the process illustrated in FIG. 13 to be explained later, this identification is performed on the initial image, but may be performed on the latest image.

The circumference regarded as the outer perimeter of the dish 210 is identified based on the Hough transform described with reference to FIG. 12. After the circumference is identified, the optical sensors WA that overlap the circumference in plan view are identified.

After the optical sensors WA overlapping the circumference in plan view are identified, the sum of the outputs of the identified optical sensors WA is calculated for each of the initial image and the latest image. Hereinafter, in the description according to the second embodiment, the term “sum for the initial image” refers to the sum of the outputs of the optical sensors WA that overlap, in plan view, the circumference of the dish 210 regarded as the outer perimeter of the dish 210 (in the initial image) by the Hough transform, among the outputs of the optical sensors WA forming the initial image. In the description according to the second embodiment, the term “sum for the latest image” refers to the sum of the outputs of the optical sensors WA that overlap, in plan view, the circumference of the dish 210 regarded as the outer perimeter of the dish 210 (in the initial image) by the Hough transform, among the outputs of the optical sensors WA forming the latest image.

In the second embodiment, if the difference between the sum for the initial image and the sum for the latest image does not exceed a third threshold, it is determined that no change in the position of the object to be detected 200 has occurred. If no change in the position of the object to be detected 200 has occurred, the outputs of the optical sensors WA that overlap the circumference of the dish 210 regarded as the outer perimeter of the dish 210 in plan view are substantially unchanged. Therefore, the difference between the sum for the initial image and the sum for the latest image should not substantially change. The third threshold is a threshold for determining whether the difference between the sum for the initial image and the sum for the latest image has not substantially changed.

In the second embodiment, if, in contrast, the difference between the sum for the initial image and the sum for the latest image exceeds the third threshold, it is determined that a change in the position of the object to be detected 200 has occurred. If the change in the position of the object to be detected 200 has occurred, the outputs of the optical sensors WA that overlap the circumference of the dish 210 regarded as the outer perimeter of the dish 210 in plan view have changed. Thus, in the determination based on the third threshold, whether the change in the position of the object to be detected 200 has occurred can be determined. Thus, in the second embodiment, the circumferential outline appeared, due to the edge of the dish 210, in the image composed of the outputs of the planar optical sensor 10 is identified by the Hough transform, and if the difference between the two overall outputs of the optical sensors WA overlapping the outline obtained at two time points separated by the predetermined amount of time or longer (the difference between the sum for the initial image and the sum for the latest image) exceeds the third threshold, it is determined that the position of the object to be detected 200 has changed. In other words, the difference between the sum of the outputs of the optical sensors WA overlapping the outline obtained at a first timing and the sum of the outputs of the optical sensors WA overlapping the outline obtained at a second timing after the first timing exceeds the third threshold, it is determined that the position of the object to be detected 200 has changed.

The first and second embodiments are the same in that the first threshold is used to determine whether the colonies have formed. However, in the second embodiment, whether the colonies have formed based on the first threshold is determined after the determination on whether the position of the object to be detected 200 has changed, and thus the second embodiment is different in processing order from the first embodiment. Specifically, the control circuit 30 of the second embodiment determines whether colonies have formed, based on the outputs of the optical sensors WA overlapping the circumferential outline. The circumferential outline is an outline corresponding to the edge of the dish 210 that appears in the data obtained from the outputs of the planar optical sensor 10. In the determination, when a fourth condition and a fifth condition are satisfied, it is determined that colonies have formed on the culture medium 215. The fourth condition is that the difference between two overall outputs of the optical sensors WA overlapping the circumferential outline obtained at two time points separated by a predetermined amount of time or longer (the difference between the sum for the initial image and the sum for the latest image) does not exceed the third threshold. The fifth condition is that, for each of one or more of the optical sensors WA in the planar optical sensor 10, the difference between its outputs obtained at the two time points, which is included in the outputs of the planar optical sensor 10 (the initial image and the latest image), exceeds the first threshold. Thus, in the second embodiment, the third threshold corresponds to the first predetermined value and the first threshold corresponds to the second predetermined value.

In other words, the fourth condition is that the difference between the sum of the outputs of the optical sensors WA overlapping the circumferential outline obtained at the first timing and the sum of the outputs of the optical sensors WA overlapping the circumferential outline obtained at the second timing does not exceed the third threshold. The fifth condition is that, for at least one of the optical sensors WA in the planar optical sensor 10, the difference between the output of the optical sensor WA obtained at the first timing and the output of the optical sensor WA obtained at the second timing exceeds the first threshold.

FIG. 13 is a flowchart of a process related to operations of the detection device 1 according to the second embodiment. The process illustrated in FIG. 13 does not include the operations at Steps S6, S7, S8, and S9 that are included in the process described with reference to FIG. 9. Instead, the process illustrated in FIG. 13 includes operations from Step S41 to Step S45 to be described later.

In the second embodiment, after the processing at Step S1, the control circuit 30 applies the Hough transform to the latest image to identify the outer perimeter of the dish 210 (Step S41). After the processing at Step S41, the processing at Step S2 is performed.

In the second embodiment, after the processing at Step S5, the control circuit 30 identifies the optical sensors WA that overlap, in plan view, the outer perimeter of the dish 210 identified at Step S41. The control circuit 30 then calculates the sum of the outputs of the identified optical sensors WA for each of the initial image and the latest image (Step S42). The processing at Step S42 calculates the sum for the initial image and the sum for the latest image in the description according to the second embodiment.

After the processing at Step S42, the control circuit 30 determines whether the difference between the sum for the initial image and the sum for the latest image exceeds the third threshold (Step S43). If the difference between the sum for the initial image and the sum for the latest image is determined to exceed the third threshold (Yes at Step S43), the control circuit 30 replaces the initial image with the latest image (Step S44). The processing at Step S44 is performed with the same intension as the processing at Step S9 described with reference to FIG. 9.

If the processing at Step S43 determines that the difference between the sum for the initial image and the sum for the latest image does not exceed the third threshold (No at Step S43), the control circuit 30 determines whether a pixel has occurred where the degree of change in output exceeds the first threshold (Step S45). The processing at Step S45 is performed with the same intension as the processing at Step S6 described with reference to FIG. 9, in order to determine whether any of the optical sensors WA has been changed in output due to colonies. That is, the processing of Step S45 is performed individually for each of the outputs of the optical sensors WA corresponding to all the pixels forming the latest image.

If the processing at Step S45 determines that the pixel has occurred where the degree of change in output exceeds the first threshold (Yes at Step S45), the processing at Step S11 is performed. If the processing at Step S45 determines that no pixel has occurred where the degree of change in output exceeds the first threshold (No at Step S45), the processing at Step S10 is performed. The second embodiment is the same as the first embodiment except in the matter noted above.

As described above, according to the second embodiment, the detection device includes the light sources (light sources 22) that emit light, the planar optical sensor (planar optical sensor 10) in which the optical sensors (optical sensors WA) that detect the light from the light sources are two-dimensionally arranged, the object placement member (object placement member 99) that is provided so as to allow the object to be detected (object to be detected 200) to be placed such that the object to be detected is interposed between the light sources and the planar optical sensor, and the processor (control circuit 30) that performs the operation control of the light sources and the planar optical sensor and the processing based on the outputs of the optical sensors. The object to be detected is the culture medium (culture medium 215) accommodated in the dish (dish 210) of the container. The processor uses the Hough transform to identify the circumferential outline appeared, due to the edge of the dish, in the outputs of the planar optical sensor, and determines that the position of the object to be detected has changed if the difference between two outputs of the optical sensor overlapping the outline that are obtained with an interval of the predetermined amount of time or longer exceeds the first predetermined value (third threshold). Therefore, the change in the output of the planar optical sensor due to the displacement of the dish can be determined to be a change different from the change in the output of the planar optical sensor due to the formation of the colonies on the culture medium.

According to the second embodiment, the processor (control circuit 30) determines whether the samples to be cultured on the culture medium (culture medium 215) have grown to generate the colonies on the culture medium, based on the outputs of the optical sensors WA overlapping the circumferential outline. The circumferential outline is an outline corresponding to the edge of the dish (dish 210) that appears in the data obtained from the outputs of the planar optical sensor 10. In the determination, when two conditions are satisfied, it is determined that the samples to be cultured on the culture medium (culture medium 215) have grown to generate the colonies on the culture medium. One of the two conditions is that the difference between the two overall outputs of the optical sensors WA overlapping the circumferential outline obtained at two time points separated by the predetermined amount of time or longer does not exceed the first predetermined value (third threshold). The other one of the two conditions is that, for each of one or more of the optical sensors WA in the planar optical sensor 10, the difference between its outputs obtained at the two time points separated by the predetermined amount of time or longer, which is included in the outputs of the planar optical sensor, exceeds the second predetermined value (first threshold). Therefore, the colonies can be detected with a high degree of accuracy after distinguishing the change in position of the object to be detected (object to be detected 200) from the formation of the colonies.

In other words, the one of the two conditions is that the difference between the sum of the outputs of the optical sensors WA overlapping the circumferential outline obtained at the first timing and the sum of the outputs of the optical sensors WA overlapping the circumferential outline obtained at the second timing after the first timing does not exceed the third threshold. The other condition thereof is that, for at least one of the optical sensors WA in the planar optical sensor 10, the difference between the output of the optical sensor WA obtained at the first timing and the output of the optical sensor WA obtained at the second timing exceeds the first threshold.

In both the first and second embodiments, the processor (control circuit 30) holds (retains) the outputs of the planar optical sensor (planar optical sensor 10) obtained first after the placement of the object to be detected (object to be detected 200). This holding (retention) of the outputs is holding (retention) of one set of the outputs (initial image) obtained earlier in time among the two sets of outputs of the planar optical sensor obtained with an interval of the predetermined amount of time or longer. The processor updates the set of the outputs obtained earlier in time with the other set of the outputs obtained later in time (latest output) of the two sets of outputs of the planar optical sensor, when the position of the object to be detected is determined to have changed. The retention and update of the outputs is performed in both the first and second embodiments. As a result, determination can be made regarding the difference between two sets of outputs: the outputs of the planar optical sensor after the position of the object to be detected has changed, and the outputs of the planar optical sensor obtained further later. That is, the determination can be made assuming that the change in position of the object to be detected has occurred once.

In other words, the processor retains the outputs of the planar optical sensor 10 (initial image) obtained at a first timing (earlier in time). When the position of the object to be detected is determined to have changed, The processor updates the retained outputs with the outputs of the planar optical sensor 10 obtained at a second timing (later in time) after the first timing.

In both the first and second embodiments, the light sources (light sources 22) include the first light sources (first light sources 22R) that emit light in a first color, the second light sources (second light sources 22G) that emit light in a second color, and the third light sources (third light sources 22B) that emit light in a third color. The output of the planar optical sensor (planar optical sensor 10) includes the first data reflecting the intensity of the light from the first light sources, the second data reflecting the intensity of the light from the second light sources, and the third data reflecting the intensity of the light from that third light sources. When the processor (control circuit 30) updates the output obtained earlier in time with the output obtained later in time, the processor updates the first data, the second data, and the third data. As a result, the processor can perform determination after obtaining the output of the planar optical sensor under a more flexible setting environment in accordance with the optical characteristics of the culture medium (culture medium 215) and the optical characteristics of the samples to be cultured. Thus, more accurate determination can be easily made.

In both the first and second embodiments, the optical member (member 26) is provided between the planar optical sensor (planar optical sensor 10) and the light sources (light sources 22) to limit the traveling direction of the light emitted from the light sources and reaching the planar optical sensor to a direction (third direction Dz) orthogonal to the surface for detecting the light by the planar optical sensor and a direction having a shallower inclination angle with respect to the orthogonal direction. This configuration can increase the accuracy of the relation between the lightness/darkness of light detected by the optical sensors (optical sensors WA) and the position of the object to be detected (object to be detected 200) in plan view.

Furthermore, in both the first and second embodiments, as illustrated in FIG. 7, the object to be detected 200 is placed on the light-transmitting member 91 in the state where the dish 210 with the culture medium 215 provided therein is provided at the upper position relative to the lid 220 and the lid 220 is provided at the lower position relative to the dish 210. This arrangement can inhibit the upward movement and condensation of moisture evaporated from the culture medium 215. Drying of the culture medium 215 can be suppressed, and better imaging and the like of the culture medium 215 can be achieved.

In the embodiments, the light sources 22 including the first light sources 22R, the second light sources 22G, and the third light sources 22B are employed as the light sources, but the light sources that can be employed in the embodiments according to the present disclosure is not limited to these light sources. For example, light sources corresponding to light in four or more colors of light may be employed, or light sources corresponding to one or two colors of light may be employed. Light in combined colors may also be used by simultaneously turning on some or all of a plurality of types of light sources that emit light in different colors. For example, when the first light sources 22R, the second light sources 22G, and the third light sources 22B are simultaneously turned on, white light is obtained.

The relative positional relation in the up-and-down direction between the planar optical sensor 10 and the light source panel 20 is not limited to the example illustrated in FIG. 7, and may be opposite to the relation illustrated in FIG. 7. The elastic member 93 is not essential to the object placement member 99. For example, the light-blocking member 92 may be fixed to the housing 90 so that the light-transmitting member 91 is interposed between the planar optical sensor 10 and the light source panel 20. In this case, a gap allowing the object to be detected 200 to be inserted therein is provided above the light-transmitting member 91 between the light-transmitting member 91 and the planar optical sensor 10 or the light source panel 20.

Although the lid 220 is not essential in the object to be detected 200, the lid 220 is more preferably provided in order to inhibit the entry of foreign matter in the culture medium 215. The dish 210 of the embodiments is the Petri dish, but is not limited thereto, and may be other components that serve in the same way as the Petri dish.

Other operational advantages accruing from the aspects described in the embodiments of the present disclosure that are obvious from the description herein, or that are conceivable as appropriate by those skilled in the art will naturally be understood as accruing from the present disclosure.

What is claimed is:

1. A detection device comprising:
a light source configured to emit light;
a planar optical sensor where a plurality of optical sensors configured to detect the light from the light source are two-dimensionally arranged;
an object placement member provided so as to allow an object to be detected to be placed such that the object to be detected is interposed between the light source and the planar optical sensor; and
a processor configured to perform operation control of the light source and the planar optical sensor and processing based on a plurality of outputs of the optical sensors, wherein
the object to be detected is a culture medium accommodated in a dish of a container, and
the processor is configured to determine that a position of the object to be detected has changed when a first condition and a second condition are satisfied,
the first condition is that, for each of one or more of the optical sensors, a difference between its outputs obtained at two time points separated by a predetermined amount of time or longer exceeds a first predetermined value, and
the second condition is that a difference between two overall outputs of the entire planar optical sensor obtained at the two time points does not exceed a second predetermined value.

2. The detection device according to claim 1, wherein
the processor is configured to determine that samples to be cultured on the culture medium have grown to generate colonies on the culture medium, when the first condition and a third condition are satisfied, and
the third condition is that the difference between the two overall outputs of the entire planar optical sensor exceeds the second predetermined value.

3. The detection device according to claim 1, wherein
the processor is configured to:
hold outputs of the planar optical sensor obtained first after the placement of the object to be detected, as outputs obtained earlier in time among the outputs of the planar optical sensor obtained at the two time points, and
update the outputs obtained earlier in time with outputs obtained later in time among the outputs of the planar optical sensor obtained at the two time points, when the position of the object to be detected is determined to have changed.

4. The detection device according to claim 3, wherein
the light source comprises:
a first light source configured to emit light in a first color;
a second light source configured to emit light in a second color; and
a third light source configured to emit light in a third color,
the planar optical sensor is configured to output data reflecting an intensity of light that has been emitted from the light source and reached the optical sensors through the object to be detected,
the data is individually obtained as:
first data reflecting the intensity of the light from the first light source;
second data reflecting the intensity of the light from the second light source; and
third data reflecting the intensity of the light from the third light source,
each of the outputs of the planar optical sensor obtained twice comprises the first data, the second data, and the third data, and
the processor is configured to, when updating the outputs obtained earlier in time with the outputs obtained later in time, update the first data, the second data, and the third data of the outputs obtained earlier in time with the first data, the second data, and the third data of the outputs obtained later in time.

5. The detection device according to claim 1, wherein an optical member is provided between the planar optical sensor and the light source to limit a traveling direction of the light emitted from the light source and reaching the planar optical sensor to a direction orthogonal to a surface for detecting the light by the planar optical sensor and a direction having a shallower inclination angle with respect to the orthogonal direction.

6. A detection device comprising:
a light source configured to emit light;
a planar optical sensor where a plurality of optical sensors configured to detect the light from the light source are two-dimensionally arranged;
an object placement member provided so as to allow an object to be detected to be placed such that the object to be detected is interposed between the light source and the planar optical sensor; and
a processor configured to perform operation control of the light source and the planar optical sensor and processing based on a plurality of outputs of the optical sensors, wherein
the object to be detected is a culture medium accommodated in a dish of a container, and
the processor is configured to:
identify a circumferential outline appeared, due to the edge of the dish, in outputs of the planar optical sensor, using the Hough transform, and
determine that the position of the object to be detected has changed, when a difference between two outputs of the optical sensor overlapping the outline that are obtained at two time points separated by a predetermined amount of time or longer exceeds a first predetermined value.

7. The detection device according to claim 6, wherein
the processor is configured to determine that samples to be cultured on the culture medium have grown to generate colonies on the culture medium, when a fourth condition and a fifth condition are satisfied,
the fourth condition is that the difference between two outputs of the optical sensor overlapping the outline that are obtained at the two time points separated by the predetermined amount of time or longer does not exceed the first predetermined value, and
the fifth condition is that, for each of one or more of the optical sensors in the planar optical sensor, a difference between its outputs obtained at the two time points exceeds a second predetermined value.

8. The detection device according to claim 6, wherein
the processor is configured to:
hold outputs of the planar optical sensor obtained first after the placement of the object to be detected, as outputs obtained earlier in time among the outputs of the planar optical sensor obtained at the two time points, and
update the outputs obtained earlier in time with outputs obtained later in time among the outputs of the planar optical sensor obtained at the two time points, when the position of the object to be detected is determined to have changed.

9. The detection device according to claim 8, wherein
the light source comprises:
a first light source configured to emit light in a first color;
a second light source configured to emit light in a second color; and
a third light source configured to emit light in a third color,
the planar optical sensor is configured to output data reflecting an intensity of light that has been emitted from the light source and reached the optical sensors through the object to be detected,
the data is individually obtained as:
first data reflecting the intensity of the light from the first light source;
second data reflecting the intensity of the light from the second light source; and
third data reflecting the intensity of the light from the third light source,
each of the outputs of the planar optical sensor obtained twice comprises the first data, the second data, and the third data, and
the processor is configured to, when updating the outputs obtained earlier in time with the outputs obtained later in time, update the first data, the second data, and the third data of the outputs obtained earlier in time with the first data, the second data, and the third data of the outputs obtained later in time.

10. The detection device according to claim 6, wherein an optical member is provided between the planar optical sensor and the light source to limit a traveling direction of the light emitted from the light source and reaching the planar optical sensor to a direction orthogonal to a surface for detecting the light by the planar optical sensor and a direction having a shallower inclination angle with respect to the orthogonal direction.
